(19) United States
(12) Patent Application Publication
(10) Pub. No.: US 2025/0100331 A1
(43) Pub. Date: Mar. 27, 2025

(54) PNEUMATIC TIRE

(71) Applicant: Toyo Tire Corporation, Itami-shi (JP)

(72) Inventor: Takuya SUKEYOSHI, Itami-shi (JP)

(73) Assignee: Toyo Tire Corporation, Itami-shi (JP)

(21) Appl. No.: 18/826,446

(22) Filed: Sep. 6, 2024

(30) Foreign Application Priority Data
Sep. 22, 2023 (JP) 2023-158256

(51) Int. Cl. B60C 13/00

(52) U.S. Cl. CPC B60C 13/001

(57) ABSTRACT

A pneumatic tire that includes: a bead; a sidewall; and a tread. Each sidewall is provided with a mark display section that includes a protruding section that protrudes outward in a tire axial direction from a profile line of the sidewall in a tire meridian plane, the mark display section being provided with cover rubber and colored rubber having a surface a portion of which is covered by the cover rubber and a remainder of which is exposed, the mark display section also being provided with a recess in a cross-sectional view of the tire meridian plane, and a recess bottom of the recess being disposed outward in the tire axial direction from a profile line of the sidewall.

### CROSS REFERENCE TO THE RELATED APPLICATIONS

This application is based on and claims the benefit of priority from Japanese Patent Application No. 2023-158256, filed on 22 Sep. 2023, the content of which is incorporated herein by reference.

### FIELD

The present invention pertains to a pneumatic tire.

### BACKGROUND

Conventionally, in order to improve the appearance of a pneumatic tire, using colored rubber to indicate a mark display section, which is displayed on a sidewall section, is known. The colored rubber is subjected to vulcanization molding on the sidewall section in a state where the surface of the colored rubber is covered with thin cover rubber, and the cover rubber at a portion corresponding to the mark display section is subsequently removed by grinding, whereby the colored rubber is exposed at the surface of the sidewall section.

### SUMMARY

In recent years, there has been an increase in requests to display mark display sections on pneumatic tires having a small tire cross-sectional height. On a pneumatic tire having a small tire cross-sectional height, the length of the mark display section shortens in the tire radial direction, and the size of the mark display section decreases. When the size of a mark display section on a pneumatic tire decreases, there are cases where there is tearing of the cover rubber that covers the colored rubber on a protruding section side surface that forms the mark display section after the tire is subjected to vulcanization molding, the colored rubber is exposed at an unintended location, and the design of the mark display section is impaired.

The present invention is made in light of the situation described above, and an object of the present invention is to provide a pneumatic tire that suppresses unintended exposure of colored rubber of a protruding section side surface that forms a mark display section.

A pneumatic tire according to the present invention is provided with: a pair of beads that each have a bead core; a pair of sidewalls that respectively extend outward in a tire radial direction from the pair of beads; and a tread that is disposed between the pair of sidewalls, each sidewall being provided with a mark display section that includes a plurality of protruding sections that protrude outward in a tire axial direction from a profile line of the sidewall in a cross-sectional view of a tire meridian plane, the mark display section being provided with cover rubber and colored rubber having a surface a portion of which is covered by the cover rubber and a remainder of which is exposed, the mark display section being also provided with a recess in a cross-sectional view of the tire meridian plane, and a recess bottom of the recess being disposed outward in the tire axial direction from the profile line of the sidewall.

By virtue of the present invention, it is possible to provide a pneumatic tire that suppresses unintended exposure of colored rubber of a protruding section side surface that forms a mark display section.

### BRIEF DESCRIPTION OF THE DRAWINGS

FIG. 1 is a view that illustrates a half section of a tire according to a first embodiment of the present invention, in a tire axial direction (tire meridian plane);

FIG. 2 is an enlarged cross-sectional view of a sidewall of the tire according to the first embodiment;

FIG. 3A is a view seen from the direction of an arrow E in FIG. 1, and illustrates the periphery of a mark display section;

FIG. 3B is a view seen from the direction of the arrow E in FIG. 1, and illustrates a minimum quadrilateral that circumscribes an outline of the mark display section;

FIG. 4A is a view seen from the direction of the arrow E in FIG. 1, and illustrates the periphery of an example of a different mark display section;

FIG. 4B is a view seen from the direction of the arrow E in FIG. 1, and illustrates a minimum quadrilateral that circumscribes an outline of the mark display section in FIG. 4A;

FIG. 5 is an enlarged cross-sectional view of a sidewall of a tire according to a second embodiment;

FIG. 6A is a view seen from the direction of an arrow E in FIG. 5 and illustrates the periphery of a mark display section;

FIG. 6B is a view seen from the direction of the arrow E in FIG. 5, and illustrates a minimum quadrilateral that circumscribes an outer edge of the mark display section;

FIG. 7A is a view seen from the direction of the arrow E in FIG. 5, and illustrates the periphery of an example of a different mark display section; and

FIG. 7B is a view seen from the direction of the arrow E in FIG. 5, and illustrates a minimum quadrilateral that circumscribes an outer edge of the mark display section in FIG. 7A.

### DETAILED DESCRIPTION OF THE EMBODIMENTS

### First Embodiment

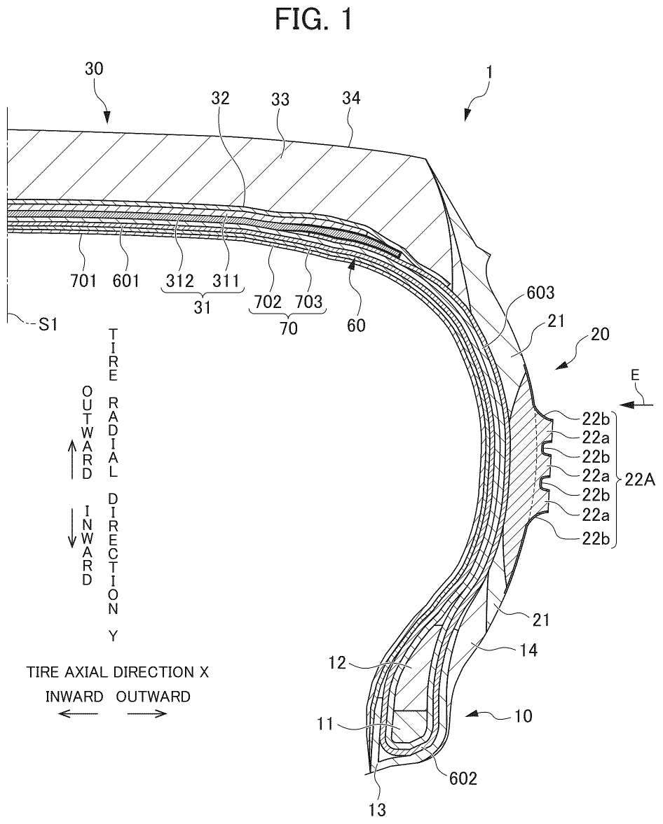

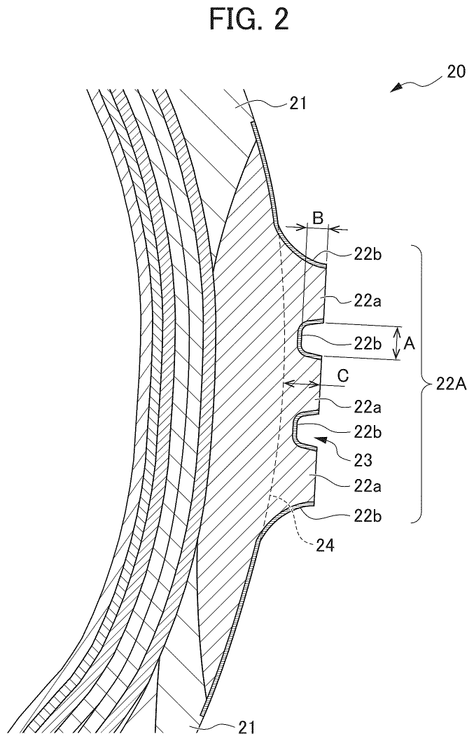

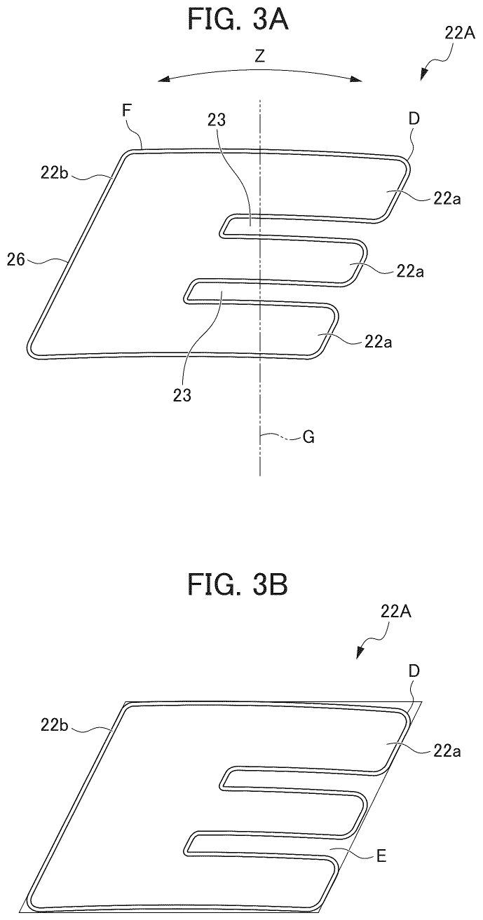

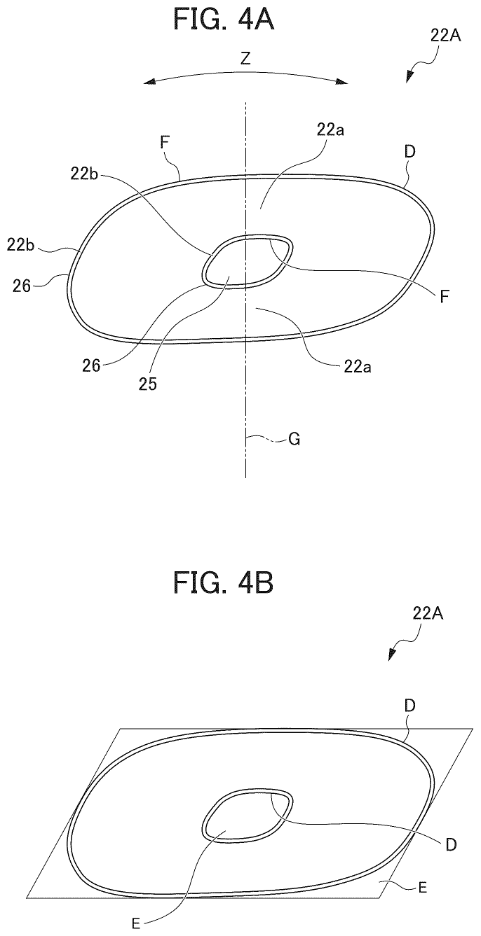

With reference to the drawings, description is given below regarding embodiments. FIG. 1 is a view that illustrates a cross-section of a tire 1, which is a pneumatic tire according to a first embodiment of the present invention, in a tire axial direction (tire meridian plane). FIG. 2 is a view that illustrates an enlarged cross-sectional view of a sidewall of the tire 1 according to an embodiment. FIG. 3A is a view seen from the direction of an arrow E in FIG. 1, and illustrates the periphery of a mark display section. FIG. 3B is a view seen from the direction of the arrow E in FIG. 1, and illustrates a minimum quadrilateral that circumscribes an outline of the mark display section. FIG. 4A is a view seen from the direction of an arrow E in FIG. 1, and illustrates the periphery of an example of a different mark display section. FIG. 4B is a view seen from the direction of the arrow E in FIG. 1, and illustrates a minimum quadrilateral that circumscribes an outline of the mark display section in FIG. 4A.

A cross-sectional view in FIG. 1 is a tire axial-direction cross-section (tire meridian cross-sectional view) of an unloaded state in which the tire 1 is mounted to a regular rim (not illustrated) and filled to a regular internal pressure. A regular rim is defined by a standard for each tire in a standards system that includes the standard with which the tire complies. For example, a regular rim is a “standard rim” in JATMA and a “measuring rim” in TRA and ETRTO. The regular internal pressure is an air pressure defined by a standard for each tire in a standard system that includes the standard with which the tire complies. In the case of a truck/bus tire or a light truck tire, the regular internal pressure is thus the maximum air pressure in JATMA, the maximum value in the table “TIRE LOAD LIMITS AT VARIOUS COLD INFLATION PRESSURES” in TRA, and “INFLATION PRESSURE” in ETRTO. The regular internal pressure is normally 180 kPa in the case of a passenger car tire, but is set to 220 kPa in the case of a tire on which “Extra Load” or “Reinforced” is written.

The basic structure of the tire 1 has left-right symmetry in a cross-section in the tire axial direction (tire meridian plane). FIG. 1 illustrates a half section for the right half of the tire 1. The left half (not illustrated) has the same structure. A reference symbol S1 in FIG. 1 is a tire equatorial surface. The tire equatorial surface S1 is orthogonal to the tire rotation axis (tire meridian), and is positioned at the center in the tire axial direction.

The tire axial direction is parallel to the tire rotation axis, and is the left-right direction on the paper surface of FIG. 1. Illustration is given as a tire axial direction X in FIG. 1. Inward in the tire axial direction is a direction that approaches the tire equatorial surface S1, and is on the left side of the paper surface of FIG. 1. Outward in the tire axial direction is a direction that goes away from the tire equatorial surface S1, and is on the right side of the paper surface of FIG. 1.

The tire radial direction is orthogonal to the tire rotation axis, and is the up-down direction on the paper surface of FIG. 1. Illustration is given as a tire radial direction Y in FIG. 1. Outward in the tire radial direction is a direction that goes away from the tire rotation axis, and is upward on the paper surface of FIG. 1. Inward in the tire radial direction is a direction that approaches the tire rotation axis, and is downward on the paper surface of FIG. 1.

In addition, a tire circumferential direction is the direction of an arc line Z direction in FIG. 3A, and the arc line Z is centered on the tire rotation axis.

As illustrated in FIG. 1, the tire 1 is provided with a pair of beads 10, a pair of sidewalls 20 that respectively extend outward in the tire radial direction from the pair of beads 10, a tread 30 that is disposed between the pair of sidewalls 20, a carcass ply 60 that is disposed spanning between the pair of beads 10, and an inner liner 70 that is disposed on a tire inner cavity side of the carcass ply 60.

The pair of beads 10 are disposed on both sides in the tire axial direction, and at inner ends in the tire radial direction. Each bead 10 has a bead core 11, bead filler 12 that extends outward in the tire radial direction from the bead core 11, a chafer 13, and rim strip rubber 14.

The bead core 11 is an annular member resulting from winding a metallic bead wire, which is coated with rubber, in the tire circumferential direction a plurality of times. The bead core 11 is a member that fulfills a function of securing the tire 1, which is filled with air, to a rim.

The bead filler 12 has a tapered shape for which the thickness decreases as the bead filler 12 extends from inward in the tire radial direction to outward in the tire radial direction. The bead filler 12 is provided in order to improve the rigidity of a peripheral portion of the bead 10, and ensure high handleability and stability. For example, the bead filler 12 is configured from a rubber having a higher hardness than that of peripheral rubber members. The surface of the bead filler 12 that is inward in the tire radial direction is joined to the surface of the bead core 11 that is outward in the tire radial direction.

The chafer 13 is further surrounds the outside of the carcass ply 60, which surrounds the bead core 11 and the bead filler 12.

The rim strip rubber 14 is disposed outward in the tire axial direction from the chafer 13 and the carcass ply 60. The rim strip rubber 14 is a member that is in contact with the rim to which the tire 1 is mounted.

Each sidewall 20 includes sidewall rubber 21, which is disposed outward from the carcass ply 60 in the tire axial direction, and a mark display section 22A. The sidewall rubber 21 and the mark display section 22A configure an outer wall surface of the tire 1. The sidewall 20 is a portion that most bends when the tire 1 is performing a cushioning action. Accordingly, flexible rubber that has fatigue resistance is normally used for the sidewall rubber 21 of the sidewall 20. Details of the mark display section 22A are described below.

The tread 30 is provided with an endless belt 31, cap ply 32, and tread rubber 33.

The belt 31 is disposed outward from the carcass ply 60 in the tire radial direction. The cap ply 32 is disposed outward from the belt 31 in the tire radial direction.

The belt 31 is a member that reinforces the tread 30. The belt 31 according to the present embodiment has a two-layer structure that is provided with an outside belt 311 and an inside belt 312. The outside belt 311 and the inside belt 312 each have a structure in which a plurality of cords such as steel cords are covered by rubber. Note that the belt 31 is not limited to a two-layer structure, and may have a structure that has one layer or three or more layers.

The cap ply 32 is a member that reinforces the tread 30 together with the belt 31. For example, the cap ply 32 has a structure in which a plurality of insulating organic fiber cords, such as polyamide fibers, are covered by rubber. By providing the cap ply 32, it is possible to address improving durability and reducing road noise when traveling.

The tread rubber 33 is disposed outward from the cap ply 32 in the tire radial direction. The tread rubber 33 is a member that configures a tread surface 34, which is the outer surface of the tread 30.

The carcass ply 60 configures ply, which becomes the skeleton of the tire 1. The carcass ply 60 is embedded within the tire 1 between the pair of beads 10 in an aspect where the carcass ply 60 passes through the pair of sidewalls 20 and the tread 30. The carcass ply 60 includes a plurality of carcass cords (not illustrated) that become the skeleton of the tire 1. For example, the plurality of carcass cords extends in the tire axial direction, and are arrayed lined up in the tire circumferential direction. Each carcass cord is configured by, inter alia, an insulating organic fiber cord made from a polyester, a polyamide, or the like. The plurality of carcass cords are coated with rubber, whereby the carcass ply 60 is configured.

The carcass ply 60 has: a ply body section 601 that extends from one bead core 11 to the other bead core 11, and extends between the tread 30 and a bead 10; a pair of bent sections 602 that are folded back from the ply body section 601 by the bead core 11; and a pair of folded-back sections 603 that respectively extend outward in the tire radial direction from the bent sections 602. The ply body section 601, the bent sections 602, and the folded-back sections 603 surround the bead filler 12 and the bead core 11. A portion of each folded-back section 603, which is outward from the bead filler 12 in the tire radial direction, overlaps with the ply body section 601.

The carcass ply 60 in embodiments has a two-layer structure, but the carcass ply 60 is not limited to a two-layer structure, and may have a structure that has one layer or three or more layers.

The chafer 13 of the above-described bead 10 is provided so as to surround a tire radial direction inward end of the carcass ply 60 that includes a bent section 602. In addition, the rim strip rubber 14 is disposed outward in the tire axial direction from the chafer 13 and the folded-back section 603 of the carcass ply 60. A tire radial direction outward end of the rim strip rubber 14 is covered by the sidewall rubber 21, which is described above.

The inner liner 70 covers the inner surface of the ply body section 601 of the carcass ply 60, and the inner surface of the chafer 13 of the pair of beads 10. The inner liner 70 is configured using air permeation-resistant rubber, and prevents air within the tire inner cavity from leaking externally. The inner surface of the inner liner 70 configures a tire inner surface 701 that is between the pair of beads 10. The inner liner 70 of the tire 1 according to the present embodiment is configured by two layers: an inside inner liner 702 and an outside inner liner 703.

FIG. 1 is a view that illustrates a cross-section of the tire 1, which is a pneumatic tire according to embodiments, in a tire axial direction (tire meridian plane). As illustrated in FIG. 1, each sidewall 20 has sidewall rubber 21 and a mark display section 22A. The mark display section 22A has colored rubber 22a and cover rubber 22b. The colored rubber 22a is disposed outward from the carcass ply 60 in the tire axial direction. In addition, the colored rubber 22a is provided on the sidewall 20 in an annular shape.

FIG. 2 is an enlarged cross-sectional view of a sidewall of the tire 1. As illustrated in FIG. 2, the cover rubber 22b is disposed on a tire outer surface side of the colored rubber 22a. In addition, the cover rubber 22b is disposed so as to cover the colored rubber 22a.

When the tire 1 is subjected to vulcanization molding, the mark display section 22A is formed, at a portion in the tire circumferential direction of the sidewall 20 of the tire 1, so as to protrude more outward in the tire axial direction than a profile line 24 of the sidewall 20. After the vulcanization molding of the tire 1, the cover rubber 22b of a portion corresponding to a portion F, which is visually recognized as a mark, is removed by grinding whereby the colored rubber 22a is exposed. As a result, the portion F, which is visually recognized as a mark that belongs to the mark display section 22A, is exposed at the surface of the sidewall 20.

As illustrated in FIG. 2, the mark display section 22A has a groove 23 that serves as a recess in a cross-sectional view of the tire meridian plane. A mold for subjecting the tire 1 to vulcanization molding has a depression for forming the mark display section 22A. Using a protuberance disposed on a portion of the depression in the mold, the groove 23 in the cross-sectional view of the tire meridian plane of the mark display section 22A is formed when subjecting the tire 1 to vulcanization molding. Note that the tire meridian plane is selected such that a later-described groove width (A) mm of the groove 23 is a maximum in the tire circumferential direction of the mark display section 22A. Note that the groove 23 has a recessed shape in a cross-sectional view of the tire meridian plane, and is open and extends one way in a front view of the mark display section 22A.

As illustrated in FIG. 2, the groove width (A) mm of the groove 23, which corresponds to the recess width (A) mm of the recess, is defined by the distance between facing surfaces of the cover rubber 22b at groove upper ends of the groove 23 after the colored rubber 22a corresponding to the mark display section 22A has been exposed. A groove depth (B) mm of the groove 23, which corresponds to a recess depth (B) mm of the recess, is defined by a groove depth (B) mm distance from the groove top end of the groove 23 to the groove bottom, which corresponds to the recess bottom.

The cover rubber 22b is disposed on the surface of the groove 23. In other words, the cover rubber 22b is achieved by being pressed by the protuberance disposed in the mold while the tire 1 is subjected to vulcanization molding. In this case, the groove 23 is formed along the shape of the protuberance, which is disposed in the mold. The cover rubber 22b, which is pressed onto a protuberance that has a thin shape and is disposed on the mold, is envisioned to incur a strong pulling force during the vulcanization molding of the tire 1. Therefore, it is considered that tearing of the cover rubber 22b occurs near the mark display section 22A. In recent years, there has been an increase in displaying a mark display section 22A on pneumatic tires having a small tire cross-sectional height. The length of the mark display section 22A in the tire radial direction is shortened in a pneumatic tire having a small tire cross-sectional height. The mark display section 22A, which has a short length in the tire radial direction, is molded using a mold that has a protuberance with a thin shape. Therefore, suppressing the occurrence of tearing by the cover rubber 22b near the mark display section 22A is required.

FIG. 3A is a view seen from the direction of an arrow E for the tire 1 according to embodiments and illustrates an example of the mark display section 22A. In FIG. 3A, the alphabetic character “E” is exemplified as an example of the portion F, which is visually recognized as a mark in the mark display section 22A. In the view seen from the arrow E in FIG. 1, which is a side surface view of the tire 1, the portion F that is visually recognized as a mark in the mark display section 22A is formed by the colored rubber 22a, which corresponds to a mark display, and an outer frame 26, the mark display including text, a shape, or a symbol that protrudes from the surface of the sidewall 20, and the outer frame 26 being in accordance with the cover rubber 22b that is disposed so as to surround the outer periphery of the colored rubber 22a. An outline of the portion F, which is visually recognized as a mark in the mark display section 22A, is an exposed surface of the colored rubber 22a at a position having a later-described protrusion height (C) in the tire axial direction, and is formed by the outer periphery of the outer frame 26, which is in accordance with the cover rubber 22b that is disposed so as to surround the outer periphery of the colored rubber 22a. Note that the view seen from the direction of the arrow E in FIG. 1 is a side surface view of the tire 1 and is a front view of the mark display section 22A.

For example, as illustrated in FIG. 3A, when the alphabetic character “E” as the mark display section 22A is disposed such that the lower side of the character faces the tire rotation axis and the upper side of the character faces outward in the tire radial direction, in a cross-sectional view of a tire meridian plane G, three horizontal lines included in the character “E” protrude from the profile line 24 of the sidewall 20 and outward in the tire axial direction as three protruding sections. In addition, in a cross-sectional view of the tire meridian plane G, two grooves 23 are provided between respective protruding sections of the three that protrude outward in the tire axial direction. In other words, the mark display section 22A is provided with grooves 23 that serve as recesses between a plurality of protruding sections, in a cross-sectional view of the tire meridian plane G.

FIG. 4A is a view seen from the direction of an arrow E for the tire 1 according to embodiments and illustrates an example of a different mark display section 22A. In FIG. 4A, the alphabetic character “O” is exemplified as an example of the portion F, which is visually recognized as a mark in the mark display section 22A. For example, as illustrated in FIG. 4A, when the alphabetic character “O” as the mark display section 22A is disposed such that the lower side of the character faces the tire rotation axis and the upper side of the character faces outward in the tire radial direction, in a cross-sectional view of a tire meridian plane G, two horizontal lines that configure the character “O” protrude from the profile line 24 of the sidewall 20 and outward in the tire axial direction as two protruding sections. In addition, in a cross-sectional view of the tire meridian plane G, there is provided a depression 25, which serves as a recess and is disposed so as to be surrounded by a plurality of protruding sections that protrude outward in the tire axial direction. Note that, in this case, a depression width (A) that serves as the recess width (A) of a recess corresponds to the groove width (A), a depression depth (B) that serves as the recess depth (B) of the recess corresponds to the groove depth (B), and a depression bottom that serves as a recess bottom corresponds to the groove bottom.

Here, a mark display section area (D) is formed by an outline of the portion F, which is visually recognized as a mark in the mark display section 22A. Note that, for a mark display section 22A that has a depression 25 disposed so as to be surrounded by a plurality of protruding sections at a portion of a mark as with the alphabetic character “O”, the mark display section area (D) results from removing the area of the depression 25 in the exposed surface of the colored rubber 22a in the front view of the mark display section 22A.

As illustrated in FIG. 3B, the mark display section 22A is a quadrilateral that circumscribes the outline of the portion F that is visually recognized as a mark in the mark display section 22A, and has a minimum quadrilateral area (E) that is formed such that this area becomes a minimum. FIG. 3B is an example of the mark display section 22A for the alphabetic character “E”. As illustrated in FIG. 4B, the mark display section 22A is a quadrilateral that circumscribes the outline of the portion F that is visually recognized as a mark in the mark display section 22A, and has a minimum quadrilateral area (E) that is formed such that this area becomes a minimum. FIG. 4B is an example of the mark display section 22A for the alphabetic character “O”.

In the present embodiment, in order to prevent a strong pulling force from being applied to the cover rubber 22b at the surface of the groove 23, the groove bottom of the groove 23, which serves as a recess bottom of a recess, is disposed more outward in the tire axial direction than the profile line 24 of the sidewall 20. As a result, the groove 23 is formed by a mold that has a protuberance having a gentle shape. Accordingly, it is possible to suitably suppress tearing of the cover rubber 22b that covers the colored rubber 22a at the groove 23, which is a protruding section side surface that forms the mark display section 22A after the tire 1 is subjected to vulcanization molding. Accordingly, it is possible to suppress unintended exposure of the colored rubber 22a at the mark display section 22A.

In addition, in the present embodiment, in a front view of the mark display section 22A that is a tire side surface view, it is desirable for the relationship between the mark display section area (D) formed by the outline of the mark display section 22A and the minimum quadrilateral area (E) of a quadrilateral circumscribing the outline of the mark display section 22A, where the quadrilateral is formed such that the area of the quadrilateral is a minimum, to be: the mark display section area (D)=the minimum quadrilateral area (E)≥70%. As a result, the tire 1 enables unintended exposure of the colored rubber 22a at the groove 23, which is a protruding section side surface of the mark display section 22A, to be more effectively suppressed.

In addition, in the present embodiment, from the perspective of being able to suitably suppress unintended exposure of the colored rubber 22a, the length of the recess depth (B) of the recess in the mark display section 22A is desirably 80% or less of the length of the protrusion height (C), and more desirably greater than or equal to 50% of the length of the protrusion height (C) and less than or equal to 80% of the length of the protrusion height (C).

### EXAMPLES

Description is given regarding examples below. As illustrated in Table 1, tires according to Examples 1 to 8 that are provided with a similar configuration to the tire 1 according to the embodiment described above and are provided with the mark display section 22A were manufactured, the groove bottom of the groove 23 that serves as a recess bottom being disposed outward in the tire axial direction from the profile line 24 of a sidewall 20. In addition, tires according to Comparative Examples 1 to 4 in which the groove bottom of the groove 23 that serves as a recess bottom being disposed on the profile line 24 of a sidewall 20 were manufactured.

For each example and each comparative example, the protrusion height (C) of the mark display section 22A was set to 1.5 mm. Regarding Examples 1 to 4, an elevation amount of the mark display section 22A was set to 0.3 mm. Regarding Examples 5 to 8, an elevation amount of the mark display section 22A was set to 0.7 mm. The elevation amount is defined in accordance with the distance from the profile line 24 on a sidewall 20 to the groove bottom of the groove 23 in the mark display section 22A. In other words, the recess depth (B) mm of the mark display section 22A in Examples 1 to 4 is 1.2 mm, and the recess depth (B) mm of the mark display section 22A in Examples 5 to 8 is 0.8 mm. Regarding Examples 1 to 4, an elevation amount ratio of the mark display section 22A was set to 20%. Regarding Examples 5 to 8, an elevation amount ratio of the mark display section 22A was set to 47%. The elevation amount ratio is the ratio of the elevation amount with respect to the protrusion height (C) of the mark display section 22A. In other words, the length of the recess depth (B) of the recess in the mark display section 22A in Examples 1 to 4 is 80% of the length of the protrusion height (C). In other words, the length of the recess depth (B) of the recess in the mark display section 22A in Examples 5 to 8 is 53% of the length of the protrusion height (C).

In addition, an alphabetic character for which the value of Y is in a range of 75.9% to 83.4% in the following formula 1 is used, formula 1 indicating the relationship between the mark display section area (D) formed by the outline of the mark display section 22A and the minimum quadrilateral area (E) of a quadrilateral circumscribing the outline of the mark display section 22A, where the quadrilateral is formed such that the area of the quadrilateral is a minimum. For each manufactured tire, whether tearing of the cover rubber 22b occurred was evaluated. Note that the evaluation result was set to good (indicated by a circle symbol (∘)) in a case where there is almost no tearing of the cover rubber 22b and unintended exposure of the colored rubber 22a could not be confirmed. The evaluation result was set to fair (indicated by a triangle symbol (Δ)) in a case where tearing occurred but exposure of the colored rubber 22a does not stand out from a tear. The evaluation result was set to poor (indicated by cross symbol (×)) in a case where tearing occurred and exposure of the colored rubber 22a stands out. More specifically, the evaluation result was set to good (∘) in a case where the ratio of the exposed length with respect to the protrusion height (C) is less than 10%, the evaluation result was set to fair (Δ) in a case where the ratio of exposed length with respect to the protrusion height (C) is 10% to 30%, and the evaluation result was set to poor (×) in a case where the ratio of the exposed length with respect to the protrusion height (C) exceeds 30%. The exposed length is the length of the colored rubber 22a that is exposed from a tear in the cover rubber 22b. Formula 1: mark display section area (D)÷minimum quadrilateral area (E)=Y %

### [Table 1]

As indicated in the Table 1, tearing of the cover rubber 22b occurred and exposure of the colored rubber 22a stood out in Comparative Examples 1 to 4, in which the groove bottom of the groove 23 that serves as a recess bottom is disposed on the profile line 24 on a sidewall 20. In contrast, tearing occurred but exposure of the colored rubber 22a did not stand out in Examples 1 to 4 in which the elevation amount ratio is 20%. Almost no tearing of the cover rubber 22b occurred and unintended exposure of the colored rubber 22a could not be confirmed in Examples 5 to 8 in which the elevation amount ratio is 47%.

From the results in Table 1, it was confirmed that by disposing the groove bottom of the groove 23 that serves as a recess bottom outward in the tire axial direction from the profile line 24 of the sidewall 20, tearing of the cover rubber 22b that covers the colored rubber 22a in the mark display section 22A after the tire 1 is subjected to vulcanization molding can be suitably suppressed. Accordingly, it is possible to suppress unintended exposure of the colored rubber 22a at the mark display section 22A. From the results in Examples 5 to 8, in a case where the recess depth (B) of the recess in the mark display section 22A is 53% of the length of the protrusion height (C), it could be confirmed that the exposed length can be suppressed to less than 0.1 mm.

In addition, it is desirable for the value of Y in formula 1 to be greater than or equal to 70%. As a result, it is possible to more suitably suppress tearing of the cover rubber 22b that covers the colored rubber 22a in the mark display section 22A after the tire 1 is subjected to vulcanization molding. In addition, the value of Y in Formula 1 may be greater than or equal to 75% and less than or equal to 85%. Even with such a tire 1, it is possible to suitably suppress tearing of the cover rubber 22b that covers the colored rubber 22a in the mark display section 22A after the tire 1 is subjected to vulcanization molding.

It is desirable for the thickness of the cover rubber 22b to be greater than or equal to 0.08 mm and less than or equal to 0.20 mm. In the case of cover rubber 22b for which the thickness of greater than or equal to 0.08 mm and less than or equal to 0.20 mm, for example, it is possible to suitably suppress tearing due to a pulling force that occurs at the cover rubber 22b, even if pressed against a protuberance on a mold.

Consideration can be given to employing a shallow groove bottom of the groove 23 in order to suppress tearing due to a pulling force that occurs at the cover rubber 22b. However, in a case where there is a short distance between the groove bottom of the groove 23 and the exposed surface of the colored rubber 22a corresponding to the mark display section 22A, the visibility of the outline of the mark display section 22A worsens, and the design is impaired. Accordingly, upon considering the relationship between design and suppression of tearing due to a pulling force, it is desirable for the groove depth (B) to be a length that is 50% or more of the protrusion height (C) of the mark display section 22A (FIG. 2), which is the distance between the profile line 24 of the sidewall 20 and the exposed surface of the colored rubber 22a. As a result, it is possible to suppress unintended exposure of the colored rubber 22a due to tearing of the cover rubber 22b, while improving design by neatly showing the outline of the mark display section 22A.

When the protrusion height (C) of the mark display section 22A that protrudes from the profile line 24 of the sidewall 20 is overly large, the appearance is poor and the distance between a protuberance and a depression on a mold increases. Therefore, a pulling force that occurs for the cover rubber 22b increases, and the possibility of tearing increases. In addition, if the amount of protrusion is extremely small, it will be difficult to clearly see the outline of the mark display section 22A, and thus the protrusion height (C) of the mark display section 22A is desirably greater than or equal to 1 mm and less than or equal to 3 mm.

Mark display sections 22A on pneumatic tires having a small tire cross-sectional height are increasingly being displayed. On a pneumatic tire having a small tire cross-sectional height, the length of the mark display section 22A shortens in the tire radial direction, and the size of the mark display section 22A decreases. In this case, the design is impaired when the length of the mark display section 22A in the tire radial direction becomes too small. Accordingly, the length of the mark display section 22A in the tire radial direction is desirably greater than or equal to 15 mm and less than or equal to 25 mm in a front view of the mark display section 22A.

When the length of the mark display section 22A in the tire radial direction is greater than or equal to 15 mm and less than or equal to 25 mm in a front view of the mark display section 22A, it is desirable for the tire cross-sectional height to be less than or equal to 155 mm. The tire cross-sectional height is more desirably less than or equal to 130 mm.

By virtue of the tire 1 according to the first embodiment described above, the following effects are achieved.

(1) The tire 1 according to the first embodiment is a pneumatic tire that includes: the pair of beads 10 that each have a bead core 11; the pair of sidewalls 20 that respectively extend outward in a tire radial direction from the pair of beads 10; and the tread 30 that is disposed between the pair of sidewalls 20, each sidewall 20 being provided with the mark display section 22A that includes a protruding section that protrudes outward in a tire axial direction from the profile line 24 of the sidewall 20 in a cross-sectional view of a tire meridian plane G, the mark display section 22A including the cover rubber 22b and the colored rubber 22a having a surface a portion of which is covered by the cover rubber 22b and a remainder of which is exposed, the mark display section 22A having a recess in a cross-sectional view of the tire meridian plane G, and a recess bottom of the recess being disposed outward in the tire axial direction from the profile line 24 of the sidewall 20.

As a result, it is possible to suppress unintended exposure of the colored rubber 22a at the mark display section 22A.

(2) In the tire 1 according to (1), in a front view of the mark display section 22A that is a tire side surface view, it is desirable for the relationship between the mark display section area (D) formed by the outline of the mark display section 22A and the minimum quadrilateral area (E) of a quadrilateral circumscribing the outline of the mark display section 22A, where the quadrilateral is formed such that the area of the quadrilateral is a minimum, to be: the mark display section area (D)÷the minimum quadrilateral area (E)≥70%.

As a result, the tire 1 enables unintended exposure of the colored rubber 22a in the mark display section 22A, to be more effectively suppressed.

(3) In the tire 1 according to (1) or (2), the thickness of the cover rubber 22b is greater than or equal to 0.08 mm and less than or equal to 0.20 mm.

As a result, the tire 1 enables unintended exposure of the colored rubber 22a in the mark display section 22A, to be more effectively suppressed. In addition, in the mark display section 22A, an exposed section of the colored rubber 22a is sufficiently wider than the thickness of the cover rubber 22b and can be visually recognized, whereby the design of the mark display section 22A improves.

(4) In the tire 1 according to (1) to (3), the length of the recess depth (B) of the recess is less than or equal to 80% of the length of the protrusion height of the mark display section, which protrudes from the profile line 24 of the sidewall 20.

As a result, the tire 1 enables unintended exposure of the colored rubber 22a in the mark display section 22A, to be more effectively suppressed.

(5) In the tire 1 according to (4), the length of the recess depth (B) of the recess is greater than or equal to 50% of the length of the protrusion height (C) of the mark display section 22A, which protrudes from the profile line 24 of the sidewall 20.

As a result, it is possible to suppress unintended exposure of the colored rubber 22a due to tearing of the cover rubber 22b, while ensuring the design by neatly showing the outline of the mark display section 22A. In addition, in the mark display section 22A, an exposed section of the colored rubber 22a is sufficiently wider than the thickness of the cover rubber 22b and can be visually recognized, whereby the design of the mark display section 22A improves.

(6) In the tire 1 according to (1) through (5), the protrusion height (C) of the mark display section 22A, which protrudes from the profile line 24 of the sidewall 20, is greater than or equal to 1.0 mm and less than or equal to 3.0 mm.

As a result, for the tire 1, a pulling force that occurs at the cover rubber 22b decreases, the possibility of tearing decreases, the contrast between the profile line 24 and the surface of the colored rubber 22a in the mark display section 22A becomes clear, and the design improves.

(7) In the tire 1 according to (1) through (6), the length of the mark display section 22A in the tire radial direction is greater than or equal to 15 mm and less than or equal to 25 mm.

Even with such a tire 1, it is possible to suppress unintended exposure of the colored rubber 22a while ensuring the design.

(8) In the tire 1 according to (1) through (7), the tire cross-sectional height is less than or equal to 155 mm.

Even with such a tire 1, it is possible to suppress unintended exposure of the colored rubber 22a while ensuring the design.

(9) In the tire 1 according to (1) through (8), the tire cross-sectional height is less than or equal to 130 mm.

Even with such a tire 1, it is possible to suppress unintended exposure of the colored rubber 22a while ensuring the design.

(10) In the tire 1 according to (1) through (9), the recess is the groove 23.

Effects for (1) through (9) are achieved even with such a tire 1.

(11) In the tire 1 according to (1) through (9), the recess is the depression 25.

Effects for (1) through (9) are achieved even with such a tire 1.

### Second Embodiment

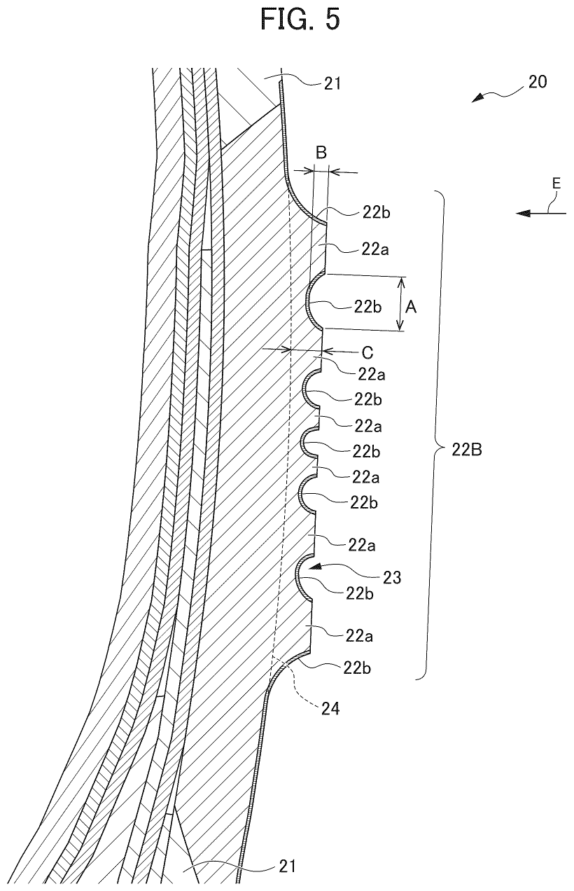

Next, with reference to FIG. 5 through FIG. 7B, description is given regarding a second embodiment of the present invention. In this second embodiment, an aspect of a mark display section 22B according to the present invention differs to that of the mark display section 22A in the first embodiment described above, and other configurations are the same or similar. Accordingly, in the following description, the same reference symbols are added to components that are the same as those in the first embodiment described above, description thereof is omitted or simplified, and description is mainly given regarding differences.

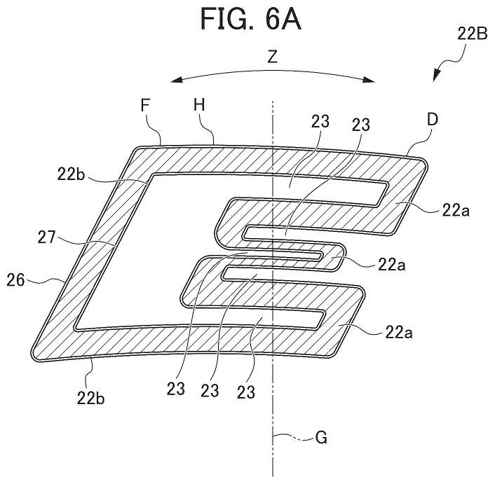

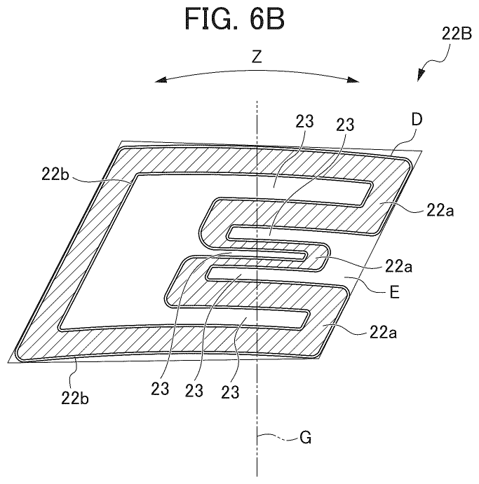

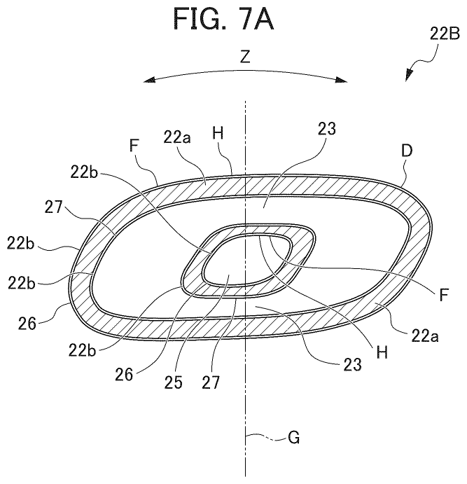

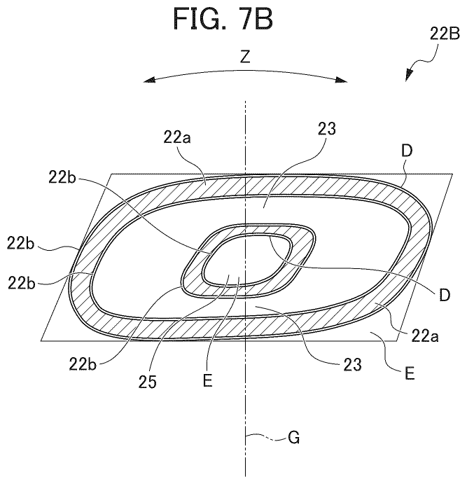

FIG. 5 is an enlarged cross-sectional view of a sidewall of a tire according to the second embodiment. FIG. 6A is a view seen from the direction of an arrow E in FIG. 5, and illustrates the periphery of a mark display section. FIG. 6B is a view seen from the direction of the arrow E in FIG. 5, and illustrates a minimum quadrilateral that circumscribes an outer edge of a mark display section. FIG. 7A is a view seen from the direction of the arrow E in FIG. 5, and illustrates the periphery of an example of a different mark display section. FIG. 7B is a view seen from the direction of the arrow E in FIG. 5, and illustrates a minimum quadrilateral that circumscribes an outer edge of the mark display section in FIG. 7A.

As illustrated in FIG. 5, the mark display section 22B has grooves 23 that serve as recesses that have different sizes, in a cross-sectional view of the tire meridian plane.

In FIG. 6A, the alphabetic character “E” is exemplified as an example of a portion F, which is visually recognized as a mark in the mark display section 22B. In a view seen from the arrow E in FIG. 5, which is a side surface view of the tire 1, the portion F that is visually recognized as a mark in the mark display section 22B is formed by the colored rubber 22a that corresponds to a mark display as well as an outer frame 26 and an inner frame 27, the mark display including text, a shape, or a symbol that protrudes from the surface of the sidewall 20, the outer frame 26 and the inner frame 27 being in accordance with the cover rubber 22b that is disposed so as to surround the outer periphery of the colored rubber 22a. The outer periphery of the portion F, which is visually recognized as a mark in the mark display section 22B, forms an outer edge H of the portion F.

For example, as illustrated in FIG. 6A, when the alphabetic character “E” as the mark display section 22B is disposed such that the lower side of the character faces the tire rotation axis and the upper side of the character faces outward in the tire radial direction, in a cross-sectional view of a tire meridian plane G, three horizontal lines included in the character “E” protrude from the profile line 24 of the sidewall 20 and outward in the tire axial direction as six protruding sections that correspond to the three horizontal lines. In addition, in a cross-sectional view of the tire meridian plane G, five grooves 23, which serve as recesses, are provided between respective protruding sections of the six that protrude outward in the tire axial direction. In other words, the mark display section 22B is provided with grooves 23 that serve as recesses between a plurality of protruding sections, in a cross-sectional view of the tire meridian plane G.

Here, in a front view of the mark display section 22B, from among the five grooves 23, the first, third, and fifth grooves 23 from the top are formed by mutually facing surfaces of the cover rubber 22b in the inner frame 27. In other words, in a front view of the mark display section 22B, from among the five grooves 23, the first, third, and fifth grooves 23 from the top are present inside the outer edge H of the portion F that is visually recognized as the mark in the mark display section 22B.

In other words, in a front view of the mark display section 22B, from among the five grooves 23, the second and fourth grooves 23 from the top are formed by the outer edge H of the portion F that is visually recognized as the mark in the mark display section 22B. In other words, in a front view of the mark display section 22B, from among the five grooves 23, the second and fourth grooves 23 from the top are present outside the outer edge H of the portion F that is visually recognized as the mark in the mark display section 22B.

Here, a mark display section area (D) is formed by the inside of the outer edge H of the portion F, which is visually recognized as a mark in the mark display section 22B.

As illustrated in FIG. 6B, the mark display section 22B is a quadrilateral that circumscribes the outer edge H of the portion F that is visually recognized as a mark in the mark display section 22B, and has a minimum quadrilateral area (E) that is formed such that this area becomes a minimum. FIG. 6B is an example of the mark display section 22B for the alphabetic character “E”.

The groove bottoms of the grooves 23 that serve as recess bottoms of recesses that are present outside of the outer edge H of the portion F, which is visually recognized as a mark in the mark display section 22B, are desirably disposed outward in the tire axial direction from the profile line 24 of the sidewall 20. As a result, it is possible to suppress unintended exposure of the colored rubber 22a in the mark display section 22B. In addition, it is possible to clearly show the outer edge H of the mark display section 22B.

In addition, in a front view of the mark display section 22B that is a tire side surface view, it is desirable for the relationship between the mark display section area (D) formed inside of the outer edge H of the mark display section 22B and the minimum quadrilateral area (E) of a quadrilateral circumscribing the outer edge H of the mark display section 22B, where the quadrilateral is formed such that the area of the quadrilateral is a minimum, to be: the mark display section area (D)=the minimum quadrilateral area (E)≥70%. As a result, the tire 1 enables unintended exposure of the colored rubber 22a at the groove 23, which is a protruding section of the mark display section 22B, to be more effectively suppressed.

More desirably, the groove bottoms of the grooves 23 that serve as recess bottoms of recesses that are present inside of the outer edge H of the portion F, which is visually recognized as a mark in the mark display section 22B, are disposed outward in the tire axial direction from the profile line 24 of the sidewall 20. As a result, it is possible to suppress unintended exposure of the colored rubber 22a in the mark display section 22B. In addition, it is possible to clearly show an inner periphery that is formed by the inner frame 27 of the mark display section 22B.

In FIG. 7A, the alphabetic character “O” is exemplified as an example of the portion F, which is visually recognized as a mark in the mark display section 22B. In a view seen from the arrow E in FIG. 5, which is a side surface view of the tire 1, the portion F that is visually recognized as a mark in the mark display section 22B is formed by the colored rubber 22a that corresponds to a mark display as well as an outer frame 26 and an inner frame 27, the mark display including text, a shape, or a symbol that protrudes from the surface of the sidewall 20, the outer frame 26 and the inner frame 27 being in accordance with the cover rubber 22b that is disposed so as to surround the outer periphery of the colored rubber 22a. The outer periphery of the portion F, which is visually recognized as a mark in the mark display section 22B, forms an outer edge H of the portion F.

For example, as illustrated in FIG. 7A, when the alphabetic character “O” as the mark display section 22B is disposed such that the lower side of the character faces the tire rotation axis and the upper side of the character faces outward in the tire radial direction, in a cross-sectional view of a tire meridian plane G, two horizontal lines that configure the character “O” protrude from the profile line 24 of the sidewall 20, outward in the tire axial direction as four protruding sections. In addition, in a cross-sectional view of the tire meridian plane G, there are provided one depression 25 that serves as a recess and two grooves 23 that serve as recesses, the depression 25 and the grooves 23 being disposed so as to be surrounded by a plurality of protruding sections that protrude outward in the tire axial direction.

Here, in a front view of the mark display section 22B, the two grooves 23 are formed by mutually facing surfaces of the cover rubber 22b in the inner frame 27. In other words, in a front view of the mark display section 22B, the two grooves 23 from the top are present inside the outer edge H of the portion F that is visually recognized as the mark in the mark display section 22B.

In addition, in a front view of the mark display section 22B, the single depression is formed by the outer edge H of the portion F that is visually recognized as the mark in the mark display section 22B. In other words, in a front view of the mark display section 22B, the single depression is present outside the outer edge H of the portion F that is visually recognized as the mark in the mark display section 22B.

Here, a mark display section area (D) is formed by the inside of the outer edge H of the portion F, which is visually recognized as a mark in the mark display section 22B. Note that, for a mark display section 22B that has a depression 25 disposed so as to be surrounded by a plurality of protruding sections at a portion of a mark as with the alphabetic character “O”, the mark display section area (D) results from removing the area of the depression 25 in the exposed surface of the colored rubber 22a in the front view of the mark display section 22B. In other words, the mark display section area (D) is formed by an inner side that is surrounded by the outer edge H of the portion F.

As illustrated in FIG. 7B, the mark display section 22B is a quadrilateral that circumscribes the outer edge H of the portion F that is visually recognized as a mark in the mark display section 22B, and has a minimum quadrilateral area (E) that is formed such that this area becomes a minimum. FIG. 7B is an example of the mark display section 22B for the alphabetic character “O”.

The depression bottom of the depression 25 that serves as a recess bottom of a recess that is present outside of the outer edge H of the portion F, which is visually recognized as a mark in the mark display section 22B, is desirably disposed outward in the tire axial direction from the profile line 24 of the sidewall 20. As a result, it is possible to suppress unintended exposure of the colored rubber 22a in the mark display section 22B. In addition, it is possible to clearly show the outer edge H of the mark display section 22B.

In addition, in a front view of the mark display section 22B that is a tire side surface view, it is desirable for the relationship between the mark display section area (D) formed inside of the outer edge H of the mark display section 22B and the minimum quadrilateral area (E) of a quadrilateral circumscribing the outer edge H of the mark display section 22B, where the quadrilateral is formed such that the area of the quadrilateral is a minimum, to be: the mark display section area (D)÷the minimum quadrilateral area (E)≥70%. As a result, the tire 1 enables unintended exposure of the colored rubber 22a at the groove 23, which is a protruding section of the mark display section 22B, to be more effectively suppressed.

More desirably, the groove bottoms of the grooves 23 that serve as recess bottoms of recesses that are present inside of the outer edge H of the portion F, which is visually recognized as a mark in the mark display section 22B, are disposed outward in the tire axial direction from the profile line 24 of the sidewall 20. As a result, it is possible to suppress unintended exposure of the colored rubber 22a in the mark display section 22B. In addition, it is possible to clearly show an inner periphery that is formed by the inner frame 27 of the mark display section 22B.

By virtue of the tire 1 according to the second embodiment described above, effects similar to those for (1) through (8) described by the first embodiment are achieved.

Description is given above regarding specific embodiments of the present invention, but the present invention is not limited to the embodiments described above. Even if variations, improvements, or the like are made within a range that enables the objective of the present invention to be achieved, a result thereof is included in the scope of the present invention

A configuration according to embodiments can be applied to pneumatic tires for various vehicles, such as light trucks, trucks, and buses in addition to pneumatic tires for passenger cars, which includes light automobiles, SUVs, and the like.

What is claimed is:

1. A pneumatic tire, comprising:
a pair of beads that each have a bead core;
a pair of sidewalls that respectively extend outward in a tire radial direction from the pair of beads; and
a tread that is disposed between the pair of sidewalls,
wherein each sidewall is provided with a mark display section that includes a protruding section that protrudes outward in a tire axial direction from a profile line of the sidewall in a cross-sectional view of a tire meridian plane,
the mark display section includes:
cover rubber, and
colored rubber having a surface a portion of which is covered by the cover rubber and a remainder of which is exposed,
the mark display section has a recess in a cross-sectional view of the tire meridian plane, and
a recess bottom of the recess is disposed outward in the tire axial direction from the profile line of the sidewall.

2. The pneumatic tire according to claim 1, wherein
in a front view of the mark display section, which is a tire side surface view, a relationship between a mark display section area (D) formed by an outline of the mark display section and a minimum quadrilateral area (E) of a quadrilateral that circumscribes the outline of the mark display section is:
mark display section area (D)÷minimum quadrilateral area (E)≥70%,
the quadrilateral being formed such that the area of the quadrilateral becomes a minimum.

3. The pneumatic tire according to claim 1, wherein
the cover rubber has a thickness that is greater than or equal to 0.08 mm and less than or equal to 0.20 mm.

4. The pneumatic tire according to claim 2, wherein
the cover rubber has a thickness that is greater than or equal to 0.08 mm and less than or equal to 0.20 mm.

5. The pneumatic tire according to claim 1, wherein
a recess depth (B) of the recess is less than or equal to 80% of a protrusion height of the mark display section that protrudes from the profile line of the sidewall.

6. The pneumatic tire according to claim 2, wherein
a recess depth (B) of the recess is less than or equal to 80% of a protrusion height of the mark display section that protrudes from the profile line of the sidewall.

7. The pneumatic tire according to claim 3, wherein
a recess depth (B) of the recess is less than or equal to 80% of a protrusion height of the mark display section that protrudes from the profile line of the sidewall.

8. The pneumatic tire according to claim 4, wherein
a recess depth (B) of the recess is less than or equal to 80% of a protrusion height of the mark display section that protrudes from the profile line of the sidewall.

9. The pneumatic tire according to claim 5, wherein
the recess depth (B) of the recess is greater than or equal to 50% of the protrusion height of the mark display section that protrudes from the profile line of the sidewall.

10. The pneumatic tire according to claim 6, wherein
the recess depth (B) of the recess is greater than or equal to 50% of the protrusion height of the mark display section that protrudes from the profile line of the sidewall.

11. The pneumatic tire according to claim 7, wherein
the recess depth (B) of the recess is greater than or equal to 50% of the protrusion height of the mark display section that protrudes from the profile line of the sidewall.

12. The pneumatic tire according to claim 8, wherein
the recess depth (B) of the recess is greater than or equal to 50% of the protrusion height of the mark display section that protrudes from the profile line of the sidewall.

13. The pneumatic tire according to claim 1, wherein
a protrusion height of the mark display section that protrudes from the profile line of the sidewall is greater than or equal to 1.0 mm and less than or equal to 3.0 mm.

14. The pneumatic tire according to claim 2, wherein
a protrusion height of the mark display section that protrudes from the profile line of the sidewall is greater than or equal to 1.0 mm and less than or equal to 3.0 mm.

15. The pneumatic tire according to claim 3, wherein
a protrusion height of the mark display section that protrudes from the profile line of the sidewall is greater than or equal to 1.0 mm and less than or equal to 3.0 mm.

16. The pneumatic tire according to claim 1, wherein
a length of the mark display section in the tire radial direction is greater than or equal to 15 mm and less than or equal to 25 mm.

17. The pneumatic tire according to claim 1, wherein
a tire cross-sectional height is less than or equal to 155 mm.

18. The pneumatic tire according to claim 1, wherein
a tire cross-sectional height is less than or equal to 130 mm.

19. The pneumatic tire according to claim 1, wherein
the recess is a groove.

20. The pneumatic tire according to claim 1, wherein
the recess is a depression.
